(19) United States
(12) Patent Application Publication
(10) Pub. No.: US 2003/0143133 A1
(43) Pub. Date: Jul. 31, 2003

(54) Air cleaning apparatus

(76) Inventor: Wei Ju Liu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/059,280

(22) Filed: Jan. 31, 2002

(51) Int. Cl. B01J 19/08

(52) U.S. Cl. 422/186.3; 423/210

(57) ABSTRACT

An air cleaning apparatus and comprising a housing that has at least one opening thereon, at least one rotation-driving device therein and at least one ultraviolet irradiator disposed in a suitable position therein. The rotation-driving device connects to a blade to drive such blade to rotate. A layer of photo catalyst is coated on the surface of the blade. The ultraviolet irradiator irradiates the photo catalytic layer on the blade to activate the photo catalyst to clean the air. The cleaned air then flows through the opening of the housing under the rotation of the blade to clean the air of an indoor and local space rapidly and produce an active air cleaning effect.

### BACKGROUND OF THE INVENTION

1. Field of the Invention

The present invention relates to an air cleaning apparatus, more particularly to an apparatus that has an ultraviolet irradiator to irradiate a rotating blade coated with a layer of photo catalyst on the surface.

2. Description of the Prior Art

Since the photo catalytic material came into the market, such material has been used for lamps as a material for illumination and air cleaning. There is a conventional air cleaning apparatus. The air cleaning apparatus has a simple ultraviolet fluorescent tube covered with a layer of photo catalyst and a fiber glass cloth, or of irradiation of a fixed photo catalytic unit with an ultraviolet fluorescent tube to clean the air around the ultraviolet fluorescent tube and the photo catalytic unit. In practical applications, however, the air cleaning effect of the apparatus is limited to the vicinity of the ultraviolet fluorescent tube. Comparatively, the air of indoor and local spaces is cleaned slowly with less effect. The apparatus, therefore, can only be deemed as a passive air cleaning apparatus applicable to small or local spaces.

In addition, U.S. Pat. No. 6,135,838 “Method of Making UV Lamp for Air Cleaning” is also granted on the basis of a ultraviolet fluorescent tube coated with photo catalyst and covered with a fiber glass cloth to provide an air cleaning effect in the vicinity of the ultraviolet fluorescent tube through the chemical action of the photo catalyst. However, this type of air cleaner is a passive air cleaning apparatus and is not capable to provide an overall air cleaning effect rapidly.

### SUMMARY OF THE INVENTION

The primary object of the present invention is to provide an air cleaning apparatus that has an ultraviolet irradiator and a blade. The blade is coated with a layer of photo catalyst and an air cleaning effect is produced by irradiating the blade with the ultraviolet irradiator.

Another object of the present invention is to provide an air cleaning apparatus with the blade rotating under the driving force of a rotation-driving device to shift the cleaned air on the surface of the blade to an airflow and actively provide an effective air cleaning effect rapidly to indoor and local spaces.

A further object of the present invention is to provide an air cleaning apparatus with the ultraviolet irradiator, blade and rotation-driving device disposed in a single housing to provide an active air cleaning function in the applications to electrical fans, air conditioners and other air conditioning apparatus.

To achieve the aforementioned objects, the air cleaning apparatus of the present invention comprises a housing that has at least one opening thereon, at least one rotation-driving device therein and at least one ultraviolet irradiator disposed in a suitable position therein. The rotation-driving device connects to a blade to drive such blade to rotate. A layer of photo catalyst is coated on the surface of the blade. The ultraviolet irradiator irradiates the photo catalytic layer on the blade to activate the photo catalyst to clean the air. The cleaned air then flows through the opening of the housing under the rotation of the blade to clean the air of an indoor and local space rapidly.

### BRIEF DESCRIPTION OF THE DRAWINGS

The foregoing and other features and advantages of the present invention will be more clearly understood from the following detailed description and the accompanying drawings, in which:

FIG. 1 is a perspective view of a first embodiment of the present invention, showing the application thereof to an air conditioner;

FIG. 2 is an exploded view of the first embodiment of the present invention;

FIG. 3 is a cross-sectional view showing a photo catalytic layer coated on a surface of a blade of the present invention;

FIG. 4 shows a second embodiment of the present invention and a refraction layer coated on the inner side of a housing thereof;

FIG. 5 shows a third embodiment of the present invention and an application thereof to an electrical fan;

FIG. 6 shows a fourth embodiment of the present invention and an application thereof to an outlet of an air conditioning apparatus; and

FIG. 7 shows a fifth embodiment of the present invention.

### DETAILED DESCRIPTION OF THE PREFERRED EMBODIMENT

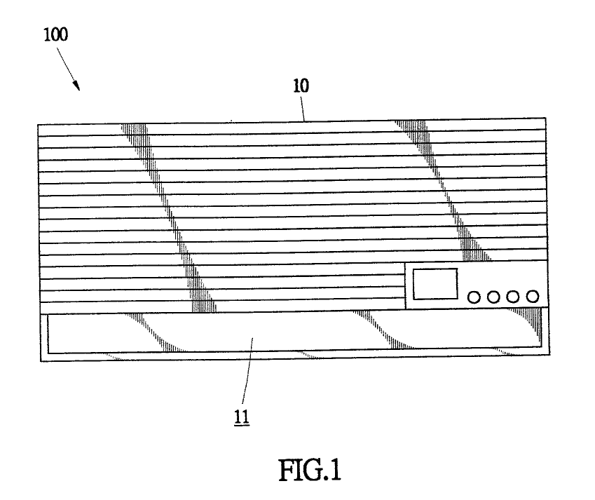

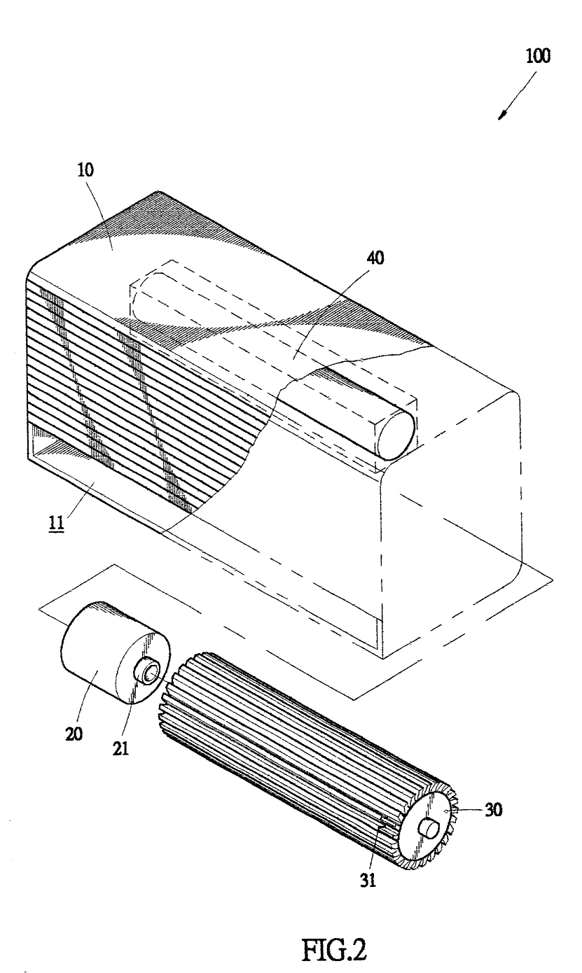

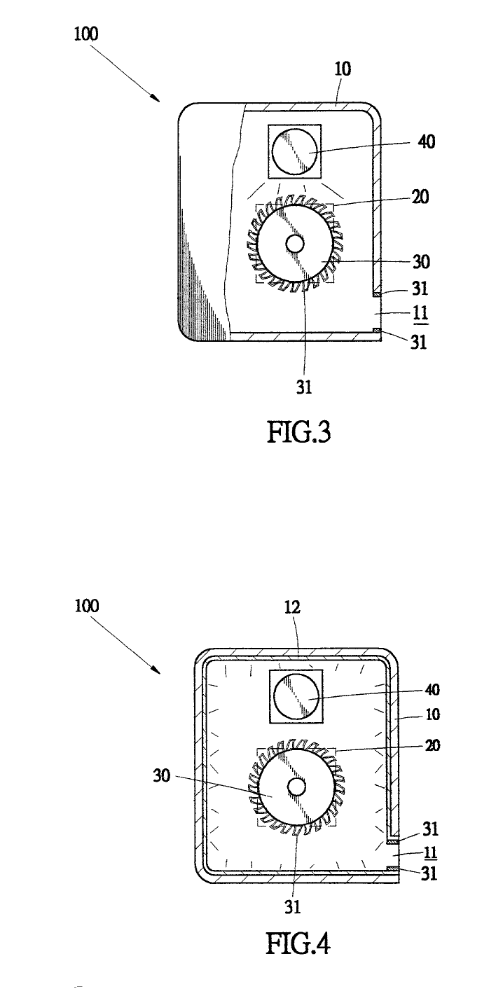

As shown in FIGS. 1 and 2, an air cleaning apparatus 100 of the present invention comprises a housing 10, at least one rotation-driving device 20, a blade 30 and, an ultraviolet irradiator 40 and at least one opening 11. The style of the housing 10 is not restricted and a housing usually used for air conditioners is selected for the present invention. The opening is disposed on a suitable position of the housing 10 and an outlet of the housing 10 is selected as the suitable position for a first embodiment of the present invention. The style of the rotation-driving device 20 is not restricted and a motor is selected for the first embodiment. The rotation-driving device 20 is disposed on a suitable position in the housing 10 and has a shaft 21 that connects to the blade 30 to drive such blade to rotate. The style of the blade 30 is not restricted and a streamlined blade is selected for the first embodiment. As shown in FIG. 3, a layer of photo catalyst 31 composed of TiO₂ is coated on a surface of the blade 30.

The ultraviolet irradiator 40 is disposed on a suitable position in the housing 10 and irradiates the surface of the blade 30. Therefore, the photo catalytic layer on the surface of the blade 30 makes a chemical reaction after being irradiated by the ultraviolet light to clean the air in the vicinity of the blade 30. The cleaned air is shifted to an flowing air under the rotation of the blade 30 and spreads outward through the opening 11 to indoor or local areas, producing an active air cleaning effect. As for the conventional technology of making chemical reaction by irradiating the photo catalyst TiO₂ with an ultraviolet lamp, see the description of U.S. Pat. No. 6,135,838.

FIG. 4 shows a second embodiment of the present invention. The difference between the first and the second embodiments lies in that the second embodiment a layer of photo catalyst 111 is coated on a surface of the opening 11 of the housing 10 and a layer of refractive material 12 is coated on the inner side of the housing 10. With such design, a multi-directional reflection effect is produced by the refraction layer 12 when the ultraviolet irradiator 40 emits ultraviolet rays, and the photo catalytic layer 31 of the blade 30 produces an air cleaning effect fully at the same time when irradiated by the ultraviolet rays to improve the speed and effectiveness of the air cleaning.

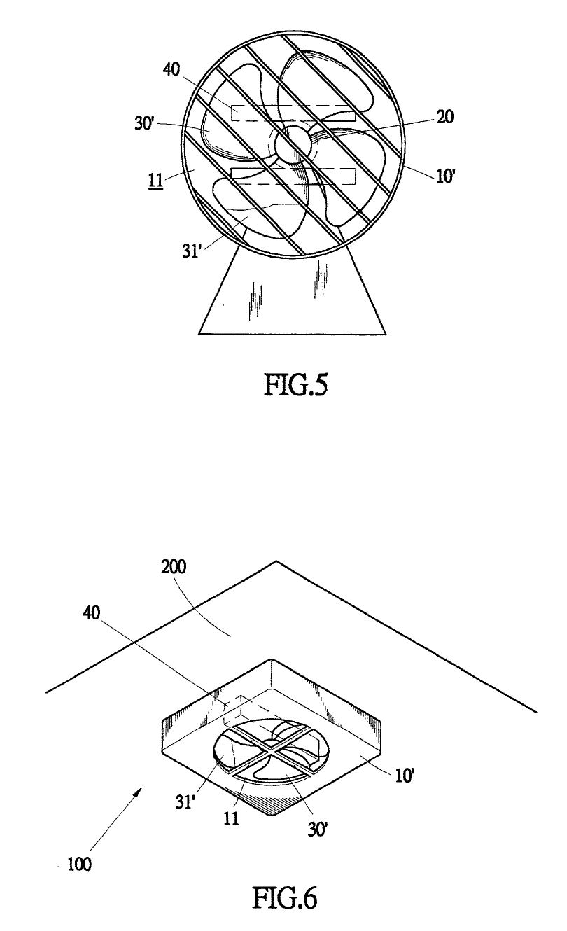

FIGS. 5 and 6 show a third and a fourth embodiments of the present invention, applied to an electrical fan and an outlet of an air conditioning apparatus, respectively. The housing 10′ has a shape of the electrical fan as shown in FIG. 5, and a shape of the outlet of the air conditioning apparatus embedded in a ceiling 200 as shown in FIG. 6. The blade 30′ of both housings has a shape of round petals to expand the area of the photo catalytic layer 31′ on the surface of the blade 30′ to be irradiated by the ultraviolet irradiator 40 and increase the volume of the air cleaning. With the aforementioned designs, the present invention can be applied to large spaces and areas.

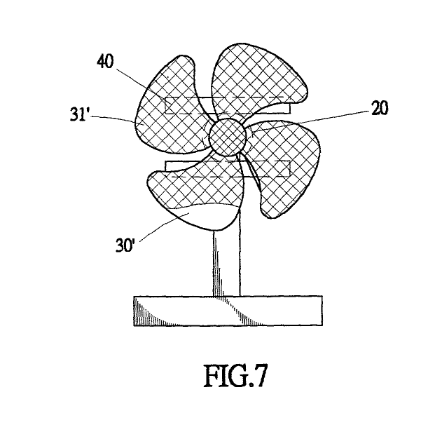

FIG. 7 shows a fifth embodiment of the invented air cleaning apparatus 100. A photo catalytic mesh 50 is added onto the blade 30. The photo catalytic mesh 50 is composed of TiO₂ and is capable to be put around the blade 30 movably. An active air cleaning effect same as in the first to fourth embodiments is produced when the ultraviolet irradiator 40 irradiates the surface of the photo catalytic mesh 50.

It is understood that the object of the present invention is to produce an active and rapid flowing air cleaning effect by using a photo catalytic type of air cleaning apparatus to improve the speed and effectiveness of air cleaning for indoor and large areas. The present invention provides a high practical value to the industries.

Although the present invention has been illustrated and described with reference to the drawings 1 to 6 and preferred embodiments thereof, it should be understood that it is in no way limited to the details of such embodiments but is capable of numerous modifications within the scope of the appended claims.

What is claimed is:

1. An air cleaning apparatus, comprising:
a housing having at least one opening;
at least one rotation-driving device disposed in said housing and having a shaft;
a blade coated with a layer of photo catalyst on a surface thereof and connecting to said shaft of said rotation-driving device, said blade being driven to rotate by said rotation-driving device and producing an airflow spreading outward through said opening; and
at least one ultraviolet irradiator disposed in said housing to irradiate the photo catalytic layer on the surface of said blade, activating the photo catalytic layer to make chemical reactions for air cleaning.

2. The air cleaning apparatus as claimed in claim 1, wherein the housing is a shell of an air conditioner and said opening is an outlet of said air conditioner.

3. The air cleaning apparatus as claimed in claim 1, wherein a layer of photo catalyst is coated on a wall surface surrounding said opening of said housing.

4. The air cleaning apparatus as claimed in claim 3, wherein the photo catalytic layer coated on the wall surface surrounding said opening is composed of TiO₂.

5. The air cleaning apparatus as claimed in claim 1, wherein the housing is a shall of an electrical fan.

6. The air cleaning apparatus as claimed in claim 1, wherein the housing is an outlet of an air conditioning apparatus embedded in a ceiling.

7. The air cleaning apparatus as claimed in claim 1, wherein a layer of refractive material is coated on an inner wall surface of said housing.

8. The air cleaning apparatus as claimed in claim 1, wherein the rotation-driving device is a motor.

9. The air cleaning apparatus as claimed in claim 1, wherein the blade is a streamlined blade.

10. The air cleaning apparatus as claimed in claim 1, wherein the blade has a shape of round petals

11. The air cleaning apparatus as claimed in claim 1, wherein the photo catalytic layer on the surface of said blade is composed of TiO₂.

12. An air cleaning apparatus, comprising:
a housing having at least an opening;
at least one rotation-driving device disposed in said housing and having a shaft;
a blade covered with a photo catalytic mesh and connecting to said shaft of said rotation-driving device, said blade being driven to rotate by said rotation-driving device and producing an airflow spreading outward through said opening; and
at least one ultraviolet irradiator disposed in said housing to irradiate the photo catalytic mesh on the surface of said blade, activating the photo catalytic mesh to make chemical reactions for air cleaning.

13. The air cleaning apparatus as claimed in claim 12, wherein the photo catalytic mesh put around said blade is a fabric coated with a layer of photo catalyst.

14. The air cleaning apparatus as claimed in claim 13, wherein the photo catalytic layer coated on said photo catalytic mesh is composed of TiO₂.
